(19) United States
(12) Patent Application Publication
(10) Pub. No.: US 2006/0094309 A1
(43) Pub. Date: May 4, 2006

(54) Components for electrical connectors, and metal strip therefore

(75) Inventors: Johannes Henricus Maria Holtkamp, Hilden (DE); Martin Giesler, Langenfeld (DE); Jean-Pierre Paul Julien Clement Frans Celis, Korbeek-Lo (BE)

Correspondence Address: STEVENS DAVIS MILLER & MOSHER, LLP, 1615 L STREET, NW, SUITE 850, WASHINGTON, DC, 20036, US

(73) Assignee: Hille & Muller GMBH, Dusseldorf (DE)

(21) Appl. No.: 10/516,540

(22) PCT Filed: Jun. 5, 2003
(86) PCT No.: PCT/EP03/06034

§ 371 Date: Oct. 4, 2005

(30) Foreign Application Priority Data
Jun. 5, 2002 (EP) 02077255.4

(51) Int. Cl. C25D 15/00; C25D 7/06; B32B 5/16; B32B 15/00

(52) U.S. Cl. 439/886; 205/138; 428/615; 428/323; 205/109; 428/929; 428/935

(57) ABSTRACT

Electrical connector or electrical switching element including a metallic core and a galvanically deposited metal containing coating layer is presented. The metal containing coating layer is deposited by electrolytic composite plating and the coating layer includes a metal matrix and distributed therein particles selected from the group of particles having electrically conductive properties, particles having lubricating properties, particles having wear resistance properties and particles having properties of increasing the temperature durability or combinations of particles from those groups. The electrical connector or electrical switching element has been made from a continuously coated metal strip comprising a metallic core and a galvanically deposited metal containing coating layer. A continuously coated metal strip for manufacturing such electrical connectors is also presented.

The invention relates to components for electrical connectors or electrical switching elements comprising a metallic core and a galvanically deposited metal containing composite coating layer.

The invention also relates to a method for the manufacture of such components, to metal strips for the manufacture of such components, to the use of such metal strip for the manufacture of an electrical connector, and to a method for manufacturing such metal strips.

In connection with the present application an electrical connector is to be understood as any means for making an electrical connection between two parts, such as but not limited to temporarily, permanently, by hand, by mechanical or electrical force, in single or multiple form.

It is well known to use metal components for connectors, the components having a metallic core and a galvanically deposited metal containing coating layer, the coating layer being applied to get an improved electrical conductivity, an improved lubrication, an improved wear resistance and/or an improved temperature durability. Such coating layer can be applied over the total surface of the metal components, or only over part or the surface, such as certain tracks on the surface. Coating examples are for instance silver and gold, which achieve good results. Other coating layers, such as tin or nickel layers, often result in a lesser or shorter-lived improvement.

To improve the properties of such cheaper layers it is known to incorporate special particles in the coating layer. Such particles are selected from the group of particles having electrically conductive properties, particles having lubricating properties, particles having wear resistance properties, and particles having properties of increasing temperature stability or combinations of particles from those groups.

U.S. Pat. No. 5,028,492 relates to a composite coating for connectors. The composite coating comprises a ductile metal matrix of a selected composition and a uniformly dispersed polymer component. In one embodiment of a method of applying the composite coating it is proposed to deposit the coating directly on a connector in an electroless or electrolytic plating process.

However, due to the separate or batchwise application of the coating on the metal components, the coated components are expensive.

To reduce costs it is known to first coat a metal strip and after that manufacture the components for the electrical connectors or electrical switching elements from that strip.

A metal strip for use in electrical connectors is known from EP 0 849 373 A1. That publication discloses a metal strip from copper, iron, nickel, zinc or its alloys as metallic core which is coated with a coating layer mainly consisting of tin or tin alloy. In the most outer skin of the coating layer, 1 to 50 atomic weight percent of carbon is incorporated. The purpose of the incorporation of carbon is to obtain an improved wear and corrosion behaviour, in particular fretting corrosion, while at the same time having an oxide free surface.

That method for making the metal strip comprises applying a tin coating layer by hot dip tinning or electrolytic tin-plating into the metallic core. Subsequently, the metallic core with the tin coating layer is fed through an oil bath at elevated temperature above the melting point of the tin or the tin alloy to incorporate carbon in the tin coating layer. Preferably, to obtain a higher carbon content, the metal strip is cooled in a second oil bath.

A problem with the known method is that at least one additional process step after applying the coating layer is required.

Another problem is that the method can only be applied to coating layer metals of relatively low melting points.

A further problem is that only carbon can be incorporated as the component to improve the desired characteristics of the metal strip as starting material for electrical connectors.

However, carbon only provides a solution for some, but not all requirements of electrical connections. So, the proposed method is only applicable for a limited number of applications of electrical connectors.

It is an object of the present invention to provide components for electrical connectors with a large amount of particles in the coating layer, preferably all throughout the coating layer.

It is a further object of the present invention to provide components for electrical connectors in which the coating layer has properties that are optimally adapted to the intended use of the electrical connectors.

It is yet a further object of the present invention to provide such components for electrical connectors that are inexpensive.

It is another object of the present invention to provide a metal strip for the manufacture of components for electrical connectors that can be manufactured in a single process step.

It is a further object of the present invention to provide a metal strip for the manufacture of components for electrical connectors which gives more freedom in the selection of the metal matrix of the coating layer and of the particles embedded therein.

According to a first aspect of the invention, these and other advantages are obtained with an electrical connector or electrical switching element comprising a metallic core and a galvanically deposited metal containing coating layer, the metal containing coating layer being deposited by electrolytic composite plating and the coating layer comprises a metal matrix and distributed therein particles selected from the group of particles having electrically conductive properties, particles having lubricating properties, particles having wear resistance properties and particles having properties of increasing the temperature durability or combinations of particles from those groups, wherein the electrical connector or electrical switching element has been made from a continuously coated metal strip comprising the metallic core and the galvanically deposited metal containing coating layer. This process is also referred to as co-deposition in this application.

According to the present invention the metal containing coating layer is deposited on an essentially flat metal strip. This brings the advantage of good controllability of the co-deposition process, a good uniformity of the thickness of the coating layer and a good homogeneity of the distribution of the particles within the coating layer, because side-effects are eliminated and non-uniform distribution of the electrical field is prevented.

There are, depending on the application, several requirements an electrical connector should fulfil. A first requirement is a low electrical resistance. The electrical resistance may increase over time due to corrosion of the outermost layer of the material of which the contacts of the connector are manufactured.

Also effects, known as tribo-oxidation or fretting may occur. In case the electrical connectors are used in a vibrating environment, closed contacts may move slightly in a tangential direction, relative to each other, thereby disrupting a formed oxide layer that can act as an abrasive, exposing non-oxidised contact material to the atmosphere. The abraded particles may deposit between the closed contacts, thereby increasing the contact resistance.

A relative movement of the closed contacts may also be caused through thermal expansion of the used materials. Through changes of the environmental temperatures or as a consequence of heat generation caused by the current passing through closed contacts, the connector may change in temperature causing relative movement of the closed contacts. This may also lead to tribo-oxidation.

Another important characteristic of a connector is the insertion force needed to insert a first part of a connector into the co-operating second part of the connector. Related hereto is the extraction force needed to disengage a connector.

The metal strip according to the invention can be given the selected, optimum characteristics in dependence of the selection of the particles embedded in the coating layer. The most important characteristics being low contact resistance, low oxidation, high corrosion resistance, low tribo-oxidation or fretting, low insertion and extraction forces.

By selecting particles having high electrical conductivity a low contact resistance can be obtained. The low contact resistance is maintained even when the metal of the metal matrix oxidises at its surface, in particular in the event the particles protrude from the metal matrix.

By selecting particles having lubricating properties, a low insertion and/or extraction force can be obtained when the particles protrude from the metal matrix. An additional advantage is that fretting is also reduced.

By selecting particles having high wear resistance properties it is achieved that under vibrating conditions or in applications requiring frequent insertions and extractions, contact wear is reduced. Consequently, fewer particles are rubbed off and built up between the contacts. This has the effect that the contact resistance increases less over time and/or use.

By selecting particles having heat resistance and conductive properties it is achieved that under high temperature conditions, the contact resistance remains low and/or corrosion or oxidation is low, i.e. the characteristics of the electrical connector are less temperature and time dependent. The particles having conductive properties will make sure that the conductivity stays low, even if part or all of the coating layer oxidises.

Preferred embodiments of the invention are given in the dependent claims.

In claim 2, soot and graphite have a good electrical conductivity; they are moreover cheap and insoluble in most aqueous solutions. Carbon nanotubes have an excellent electrical conductivity, and are insoluble in most aqueous solutions. The ceramic particles TiN, TiB, CrN, TiS, TaS₂, MoS₂ and TiO are well known conductive materials, readily available, and insoluble in most aqueous solutions.

PTFE, polyimide and polyamide as mentioned in claim 3 are well known for their lubricating properties, they are readily available, and insoluble in most aqueous solutions.

In claim 4, the ceramic particles as mentioned in claim 2 have a high wear resistance. Also carbon nanotubes have a high wear resistance.

Pure carbon, graphite, MoS₂, BN and other particles as mentioned in claim 5 are well known for their lubricating properties.

The metals mentioned in claim 6 are established materials in electroplating, and inexpensive. The selection of the metal of the metal matrix can be based on the purpose for which the electrical connector is used and the conditions of use.

The metal used for the metal core can be selected from a wide range of metals, also dependent on the purpose for which the electrical connector is used and the conditions of use. The metals mentioned in claim 7 are commonly used metals for use in connectors.

By co-depositing the metal of the metal matrix and the particles, it is possible to select the size of the particles within a broad range, such as between 0.001 μm and 15 μm, dependent on the composition of the particles and their purpose in the coating layer. Size is to be interpreted as the diameter of the smallest sphere enclosing a particle. The maximum size is determined by the thickness of the coating; larger particles are difficult to incorporate and give a non-homogeneous distribution of the properties to be achieved. Particles smaller than 1 nm loose their properties as particle.

Preferably the particles have a size in the range of 0.1 μm and 15 μm, because particle smaller than 0.1 μm are difficult to incorporate in metal layers and difficult to disperse in aqueous solutions without coagulating.

This co-depositing also makes it possible to embed a broad range of volume fractions of the distributed particles in the coating layer, again dependent on the requirements during operation or the lifetime of the electrical connector. Preferred is a volume fraction of the distributed particles in the co-deposited coating layer in the range of 0.7% to 30% of the volume of the coating layer. The volume fraction also depends on the type of particle used. Below 0.7% the particle will not be effective. Above 30% the co-deposited coating will loose its coherence.

A thickness of the strip between 0.1 and 1.5 mm is best suited for manufacturing electrical connector and switching elements.

Since the process of co-depositing on a flat strip is very well controllable, the thickness of the coating layer can be matched very well to the requirements put on the connectors. Coating layers in the range of 0.2-10 μm are preferred. Thinner layers in general do not meet the requirements; for thicker layers alternative processes could be considered in view of the time required for the co-deposition of the metal matrix and the distributed particles makes it possible to homogeneously distribute the particles in thickness direction within the coating layer. The coating layer, therefore, also has uniform characteristics over the thickness and the total coating layer does not need to be thicker than required for normal operation during the lifetime of the connector or the apparatus in which the connector is used.

According to a second aspect, the invention is also embodied in a method for the manufacture of components for electrical connectors according to the first aspect of the invention, wherein a metallic core is fed through a galvanic bath and a coating layer is deposited in a continuous or semi-continuous manner on at least one side of the metallic core.

Due to the continuous or semi-continuous co-deposition of the matrix of metal and particles, an inexpensive strip is provided from which the electrical components can be manufactured.

According to a third aspect of the invention, there are provided continuously coated metal strips for the manufacture of components for electrical connectors or electrical switching elements, such as described in the first aspect of the invention. The metal strips as described in claims 14 to 18 are suitable for fabricating these components. The advantages of such strips will be clear from the discussion of the first and second aspect of the invention. The most important aspect is that such continuously coated strips with the co-deposited layer of a metal matrix with incorporated particles is less expensive to produce than the known strips.

The invention also relates to the use of such a continuously coated strip, and to a method to manufacture such a continuously coated metal strip.

The method makes it possible to apply in one single process step a metal matrix and distribution therein particles which can be selected from a wide range of materials, dependent on the desired characteristics of the composite coating layer.

The invention will be elucidated referring to the following experiments and results.

In the following 7 examples, a metal strip has been coated by co-deposition with a matrix of a metal containing particles. The particles provide an extra electrical conductivity, lubrication, wear resistance and/or temperature durability.

### EXAMPLE 1

### Nickel Graphite Coating With Graphite Particles On Steel

Steel strip is plated with a co-deposit nickel-graphite coating in a continuous plating line. The line is a vertical plating line with a total anode area of 300 dm². The steel strip has a thickness of 0.2-0.4 mm and it will be first degreased, rinsed, activated in sulfuric acid, and again rinsed. Next the steel strip is plated with nickel-graphite co-deposit coating:

Bath Composition:

| Nickel | 79 | g/l |
|---|---|---|
| Chloride | 27 | g/l |
| Boric Acid | 35 | g/l |
| Graphite | 48 | g/l |
| Surfactant | 0.5 | g/l |
| PH | 2.8 | |
| Temperature | 60° | C. |
| Current density | 15 | A/dm² |
| Strip velocity | 11 | m/min |
| Coating thickness | 1 | μm |

All the above values are approximate values. The coating contains approximately 9% graphite. The graphite particles are non-spherical and on average have a size of approximately 5 μm.

### EXAMPLE 2

### Nickel Coating With Graphite Particles On Copper

Similar to example 1, but now the steel strip is substituted by a copper strip. Here the coating is the same as in example 1 and again the coating contains approximately 9% graphite particles.

### EXAMPLE 3

### Nickel Coating With TiN Particles On Steel

Similar to example 1, but now the graphite particles are substituted by titanium nitride particles (40 g/l). The TiN particles are spherical and have a diameter of approximately 5 μm. The coating contains approximately 3% TiN particles.

### EXAMPLE 4

### Nickel Coating With TiN And Graphite On Steel

Similar to example 3, extra amount of 40 g/l graphite was added. The coating contains approximately 3% graphite particles and 3% TiN particles.

### EXAMPLE 5

### Tin Coating With Graphite On Steel

Similar to example 1, but the nickel is substituted by tin.

Bath Composition:

| NaOH | 10 | g/l |
|---|---|---|
| NaSnO₃ | 100 | g/l |
| graphite | 20 | g/l |
| PH | 13 | |
| Temperature | 75° | C. |
| Current density | 2.5 | A/dm² |
| Strip velocity | 4 | m/min |
| Coating thickness | 1 | μm |

Here the current density has to be low in view of the deposition of tin. The coating contains approximately 1% graphite particles.

### EXAMPLE 6

### Nickel Coating With CrN Particles On Steel

Similar to example 3, but the TiN particles are substituted by CrN particles. The CrN particles are spherical and have a diameter of approximately 5 μm. The coating contains approximately 3% CrN particles.

### EXAMPLE 7

### Copper Coating With PTFE Particles On Steel

The same co-deposition line has been used as in example 1, but nickel has been substituted by copper and graphite by PTFE.

Bath Composition:

| Coppersulfate | 200 | g/l |
|---|---|---|
| Sulfuric acid | 70 | g/l |
| PTFE | 30 | g/l |
| Surfactants | 160 | mg/l |
| PH | 0.4 | |
| Temperature | 50° | C. |
| Current density | 5 | A/dm² |
| Strip velocity | 2 | m/min |
| Coating thickness | 2 | μm |

The PTFE particles are spherical and have a diameter of approximately 0.3 μm. The coating contains approximately 25 volume % (or 8 weight %) PTFE particles.

All percentages above are in weight %, unless otherwise specified.

The coated metal has been tested, and to be able to compare it with coating layers without particles, some control test have been performed on a metal substrate (steel) having a coating layer of pure nickel or pure tin.

The tests have been performed to measure the contact resistance, see table 1, the friction coefficient, see table 2, the wear resistance, see table 3, and the temperature durability, see table 4.

For the contact resistance measurement the sample was placed at 8 bar pressure, and measured under DC conditions in a 4-point manner. Coefficient of friction was measured together with the wear resistance measurement in a fretting test.

TABLE 1
contact resistance of various composite plated
systems in mOhm · cm2

| Material | Resistance in mOhm · cm2 |
|---|---|
| Control (nickel) | 90 |
| Nickel-graphite | 19 |
| Nickel-titaniumnitride | 18 |
| Nickel-chromiumnitride | 18 |

TABLE 2
friction coefficient of various composite plated systems

| | |
|---|---|
| Control (nickel) | 0.6 |
| Nickel-graphite | 0.15 |
| Nickel-PTFE | 0.07 |
| Control (copper) | 0.9 |
| Copper-PTFE | 0.08 |
| Control (tin) | 0.7 |
| Tin-graphite | 0.4 |

TABLE 3
wear resistance. Size of the wear track after fretting
test in micrometers

| | |
|---|---|
| Control (nickel) | 700 |
| Nickel-PTFE | 200 |
| Nickel-graphite | 400 |
| Copper-PTFE | 200 |

TABLE 4
temperature durability: contact resistance after exposure
for prolonged time at 250 C.

| | |
|---|---|
| Control 1 (nickel) | 600 |
| Control 2 (tin) | total degradation |
| Nickel-graphite | 34 |

The tables clearly show that in all cases the co-deposition of the selected particles in the nickel or tin coating provides a major improvement over the pure nickel or tin layer.

1. Electrical connector or electrical switching element comprising a metallic core and a galvanically deposited metal containing coating layer, the metal containing coating layer being deposited by electrolytic composite plating and the coating layer comprises a metal matrix and distributed therein particles selected from the group consisting of particles having electrically conductive properties, particles having lubricating properties, particles having wear resistance properties and particles having properties of increasing the temperature durability or combinations of particles from those groups, wherein the electrical connector or electrical switching element has been made from a continuously coated metal strip comprising the metallic core and the galvanically deposited metal containing coating layer.

2. Electrical connector or electrical switching element according to claim 1, wherein the electrically conductive particles are selected from the group consisting of carbonaceous materials, and electrically conductive ceramic materials comprising borides, nitrides; sulfides, and electrically conductive oxides.

3. Electrical connector or electrical switching element according to claim 1, wherein the particles having lubricating properties are selected from the group consisting of polymers, carbon containing particles, ceramic particles, and lubricating means containing capsules, and optionally the particles having lubricating properties also having corrosion inhibiting additives.

4. Electrical connector or electrical switching element according to claim 1, wherein the particles having wear resistance properties are selected from the group consisting of ceramic particles, and optionally carbonaceous nanotubes.

5. Electrical connector or electrical switching element according to claim 1, wherein the particles having properties of increasing temperature durability are selected from the group consisting of heat resistant and conductive ceramic particles, and carbonaceous materials.

6. Electrical connector or electrical switching element according to claim 1, wherein the co-deposited metallic matrix of the coating layer on the continuously coated metal strip mainly comprises one or more metals selected from the group consisting of nickel, copper, tin, zinc, chromium and alloys or combinations thereof.

7. Electrical connector or electrical switching element according to claim 1, wherein the metallic core mainly comprises one or more metals selected from the group consisting of low carbon steel, high-strength steel, stainless steel, copper, bronze, brass and multilayer composites alloys or mixtures thereof.

8. Electrical connector or electrical switching element according to claim 1, wherein the distributed particles have a size in the range of 0.001-15 μm.

9. Electrical connector or electrical switching element according to claim 1, wherein the volume fraction of the distributed particles in the co-deposited coating layer is in the range of 0.7% to 30% of the volume of the coating layer.

10. Electrical connector or electrical switching element according to claim 1, wherein the thickness of the metal strip is in the range of 0.1 to 1.5 mm.

11. Electrical connector or electrical switching element according to claim 1, wherein the coating layer has a thickness in the range from 0.2-10 μm.

12. Electrical connector or electrical switching element according to claim 1, wherein the particles of at least one group are homogeneously distributed in the coating layer.

13. Method for the manufacture of an electrical connector or electrical switching element according to claim 1, comprising:
feeding a metallic core through a galvanic bath and
depositing a coating layer on at least one side of the metallic core in a continuous or semi-continuous manner, wherein a metal matrix and particles selected from the group of particles having electrically conductive properties, particles having lubricating properties, particles having wear resistance properties or particles having properties of increasing temperature stability and combinations thereof, are co-deposited on the metal core to form the coating layer, and
manufacturing the electrical connector or electrical switching element from the coated metal core.

14. Continuously coated metal strip according to claim 32, for the manufacture of components for electrical connectors or electrical switching elements comprising said metallic core and said galvanically deposited metal containing coating layer, the metal containing coating layer being deposited by electrolytic composite plating and the coating layer comprises said metal matrix and distributed therein particles selected from the group consisting of particles having wear resistance properties.

15. Continuously coated metal strip according to claim 14, wherein the particles having wear resistance properties are selected from the group consisting of ceramic particles, and optionally carbonaceous nanotubes.

16. Continuously coated metal strip according to claim 32, for the manufacture of components for electrical connectors or electrical switching elements comprising
said metallic core and a galvanically deposited metal containing coating layer,
the metal containing coating layer being deposited by electrolytic composite plating and the coating layer comprises said metal matrix and distributed therein particles selected from the group of electrically conductive particles, selected from the group consisting of electrically conductive ceramic materials comprising borides,; nitrides sulfides, and electrically conductive oxides.

17. Continuously coated metal strip according to claim 32, for the manufacture of components for electrical connectors or electrical switching elements comprising said metallic core and said galvanically deposited metal containing coating layer, the metal containing coating layer being deposited by electrolytic composite plating and the coating layer comprises said metal matrix and distributed therein particles selected from the group of particles having lubricating properties, selected from the group consisting of polymers, ceramic particles, and lubricating means containing capsules.

18. Continuously coated metal strip according to claim 32, for the manufacture of components for electrical connectors or electrical switching elements comprising said metallic core and said galvanically deposited metal containing coating layer, the metal containing coating layer being deposited by electrolytic composite plating and the coating layer comprises said metal matrix and distributed therein particles selected from the group of particles having properties of increasing temperature durability, selected from the group consisting of heat resistant and conductive ceramic particles.

19. A method of use of a continuously coated metal strip according to claim 32, comprising manufacturing an electrical connector or electrical switching element comprising at least a portion of the strip.

20. Method for the manufacture of a continuously coated metal strip according to claim 32, wherein a metallic core is fed through a galvanic bath and a coating layer is deposited on at least one side of the metallic core in a continuous or semi-continuous manner, wherein a metal matrix and particles selected from the group of particles having electrically conductive properties, particles having lubricating properties, particles having wear resistance properties of particles having properties of increasing temperature stability and combinations thereof, are co-deposited on the metal core to form the coating layer.

21. Electrical connector or electrical switching element according to claim 1, wherein the electrically conductive particles are selected from the group consisting of carbonaceous materials selected from the group consisting of soot, graphite and carbonaceous nanotubes, and electrically conductive ceramic materials comprising borides selected from the group consisting of titanium boride and iron boride; nitrides selected from the group consisting of titanium nitride and chromium nitride; sulfides selected from the group consisting of titanium sulfide, tantalium disulfide and molybdenum disulfide, and titanium oxide.

22. Electrical connector or electrical switching element according to claim 1, wherein the particles having lubricating properties are selected from the group consisting of polymers, selected from the group consisting of PTFE, polyimide and polyamide, carbon containing particles selected from the group consisting of essentially pure carbon and graphite, ceramic particles selected from the group consisting of molybdenum disulphide and borium nitride, and lubricating means containing capsules selected from the group consisting of capsules containing polyphenylether or organic lubricating means, and optionally the particles having lubricating properties also having corrosion inhibiting additives.

23. Electrical connector or electrical switching element according to claim 1, wherein the particles having wear resistance properties are selected from the group consisting of ceramic particles selected from the group consisting of aluminium oxide, zirconium oxide, silicon carbide, boron nitride and titanium nitride, and optionally carbonaceous nanotubes.

24. Electrical connector or electrical switching element according to claim 1, wherein the particles having properties of increasing temperature durability are selected from the group consisting of heat resistant and conductive ceramic particles selected from the group consisting of aluminium oxide, zirconium oxide, silicon carbide, diamond-like boron nitride and titanium nitride, and carbonaceous materials selected from the group consisting of soot, graphite and carbonaceous nanotubes.

25. Electrical connector or electrical switching element according to claim 1, wherein the distributed particles have a size in the range of 0.1-15 μm.

26. Electrical connector or electrical switching element according to claim 1, wherein the coating layer has a thickness in the range of 1-5 μm.

27. Electrical connector or electrical switching element according to claim 1, wherein the particles of all groups of particles, are homogeneously distributed in the coating layer.

28. Continuously coated metal strip according to claim 14, wherein the particles having wear resistance properties are selected from the group consisting of ceramic particles selected from the group consisting of aluminium oxide, zirconium oxide, silicon carbide, boron nitride and titanium nitride, and optionally carbonaceous nanotubes.

29. The continuously coated metal strip of claim 16, wherein the coating layer comprises said metal matrix and distributed therein particles selected from the group of electrically conductive particles, selected from the group consisting of electrically conductive ceramic materials comprising borides, selected from the group consisting of titanium boride and iron boride; nitrides selected from the group consisting of titanium nitride and chromium nitride; sulfides selected from the group consisting of titanium sulfide, tantalium disulfide and molybdenum disulfide, and titanium oxide.

30. The continuously coated metal strip of claim 17, wherein the coating layer comprises a metal matrix and distributed therein particles selected from the group consisting of particles having lubricating properties, selected from the group consisting of polymers selected from the group consisting of PTFE, polyimide and polyamide, ceramic particles selected from the group consisting of molybdenum disulphide and borium nitride, and lubricating means containing capsules selected from the group consisting of capsules containing polyphenylether or organic lubricating means.

31. The continuously coated metal strip of claim 18, wherein the heat resistant and conductive ceramic particles are selected from the group consisting of aluminium oxide, zirconium oxide, silicon carbide, diamond-like boron nitride and titanium nitride.

32. Continuously coated metal strip for the manufacture of components for electrical connectors or electrical switching elements comprising a metallic core and a galvanically deposited metal containing coating layer, the metal containing coating layer being deposited by electrolytic composite plating and the coating layer comprises a metal matrix and distributed therein particles selected from the group consisting of particles having wear resistance properties, electrically conductive particles, particles having lubricating properties, particles having properties of increasing temperature durability and combinations thereof.
